(19) United States
(12) Patent Application Publication
(10) Pub. No.: US 2015/0019722 A1
(43) Pub. Date: Jan. 15, 2015

(54) DETERMINING, MANAGING AND DEPLOYING AN APPLICATION TOPOLOGY IN A VIRTUAL ENVIRONMENT

(71) Applicant: Infosys Limited, Bangalore (IN)

(72) Inventors: Sudheeshchandran Narayanan, Bangalore (IN); Ramkumar Krishnamurthy Dargha, Bangalore (IN); Vishwanath Narayan, Bangalore (IN); Suresh Karra, Bangalore (IN); Vishvanath Muthyala, Bangalore (IN); Sanjeev Kumar, Bangalore (IN)

(73) Assignee: Infosys Limited, Bangalore (IN)

(21) Appl. No.: 14/329,789

(22) Filed: Jul. 11, 2014

(30) Foreign Application Priority Data
Jul. 15, 2013 (IN) 3135/CHE/2013

(51) Int. Cl. H04L 29/08; H04L 12/26

(52) U.S. Cl. CPC H04L 67/1008; H04L 43/0876
USPC 709/224

(57) ABSTRACT

A method and a system for determining, managing and deploying an application topology in a virtual environment are provided. QoS parameters, workload attributes and application topology elements are received. An application topology and a deployment strategy are determined based on the received one or more of QoS parameters, workload attributes, application topology elements and application topology patterns. Virtual environment components are identified based on the determined application topology and the deployment strategy. After the application topology is deployed, the QoS parameters of the virtual environment components are monitored. After analyzing the monitored QoS parameters with expected QoS parameters, a QoS parameter variance is detected. If the detected QoS parameter variance exceeds the pre-defined threshold, a corrective action for the application topology is determined.

### FIELD

The field relates to the field of virtual environment and more particularly to a method and a system for determining, managing and deploying an application topology in the virtual environment.

### BACKGROUND

With the advent of virtualization technology, determining and deploying an application topology on virtual machines (herein referred as VMs) has become one of the main concerns of the organizations. Typically, an administrator is enabled to group the applications and VMs into logical groupings and such logical groupings are provisioned by the administrator using tools which automate the provisioning of the applications onto the VMs based on the inputs provided by the administrator. Alternatively, an “appliance” can be created which may include the entire stack related to the hardware, OS, hypervisor, system software, applications and configurations that are required to be provisioned.

Once the application topology is deployed onto the VMs, managing the application topology in a virtual environment becomes important. Generally, dynamic load balancing techniques are used to scale-up instances in case the load increases or scale-down in case the load decreases. This is typically accomplished by the deployment topology through the creation of software or hardware load balancers.

Though, techniques exist to cater the problem of automated provisioning and load balancing, however, the existing techniques does not consider the Quality of Service (herein referred as QoS) parameters while provisioning an application topology in a virtual environment.

Therefore, there is a general need to manage an application topology which has been determined based on the QoS parameters. Several aspects of the present disclosure discloses a method and a system for determining, managing and deploying an application topology in the virtual environment as described in details in below sections.

### SUMMARY

A method and a system for determining, managing and deploying an application topology in a virtual environment are provided. QoS parameters, work load attributes and application topology elements are received. An application topology and a deployment strategy are determined based on the received one or more of QoS parameters, work load attributes, application topology elements and application topology patterns. Virtual environment components are identified based on the determined application topology and the deployment strategy. After the application topology is deployed, the QoS parameters of the virtual environment components are monitored. After analyzing the monitored QoS parameters with expected QoS parameters, a QoS parameter variance is detected. If the detected QoS parameter variance exceeds the pre-defined threshold, a corrective action for the application topology is determined.

### BRIEF DESCRIPTION OF THE DRAWINGS

FIG. 1 illustrates a process flow for determining and deploying an application topology in a virtual environment.

FIG. 2 illustrates a process flow for managing an application topology in a virtual environment.

FIG. 3 illustrates an example embodiment of an application topology determined based on the QoS parameters.

FIG. 4 shows an exemplary system depicting the components required to determining, managing and deploying an application topology in a virtual environment.

FIG. 5 shows an exemplary computing device useful for performing processes disclosed herein.

### DETAILED DESCRIPTION

The following description is the full and informative description of the best method and system presently contemplated for carrying out the present invention which is known to the inventors at the time of filing the patent application. Of course, many modifications and adaptations will be apparent to those skilled in the relevant arts in view of the following description in view of the accompanying drawings. While the invention described herein is provided with a certain degree of specificity, the present technique may be implemented with either greater or lesser specificity, depending on the needs of the user. Further, some of the features of the present technique may be used to get an advantage without the corresponding use of other features described in the following paragraphs. As such, the present description should be considered as merely illustrative of the principles of the present technique and not in limitation thereof.

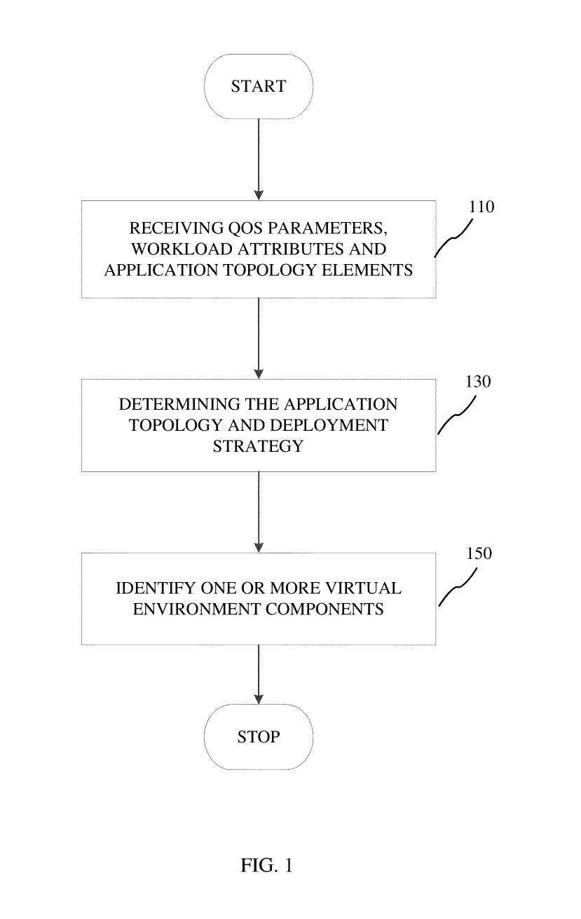

FIG. 1 illustrates a process flow for determining and deploying an application topology in a virtual environment. At step 110, QoS parameters, workload attributes and application topology elements are received. QoS parameters herein referred to as a set of service requirements that need to be met to achieve a level of quality. QoS parameters may include, but not limited to, parameters such as number of users, number of concurrent users, throughput, response time, utilization level, latency etc. Workload attributes may include one or more attributes such as CPU utilization, memory utilization, network utilization, storage utilization and the like.

Application topology generally, comprises of combination of one or more application topology elements required for the application to be deployed in a virtual environment. Such application topology elements may include, but not limited to, number of application packages, interdependencies between the application packages and configuration of the application packages. The application package could be either a custom built application or a standard off the shelf application packages like ERP, CRM etc. The application topology can consist of multiple applications and application packages. One application may depend on another application or application package for the application topology pattern to function properly. An application configuration consists of application specific parameters such as application executable(s), application server(s), database server(s), content management server(s), or a combination thereof and associated scripts to make the application deploy and run on a virtual environment.

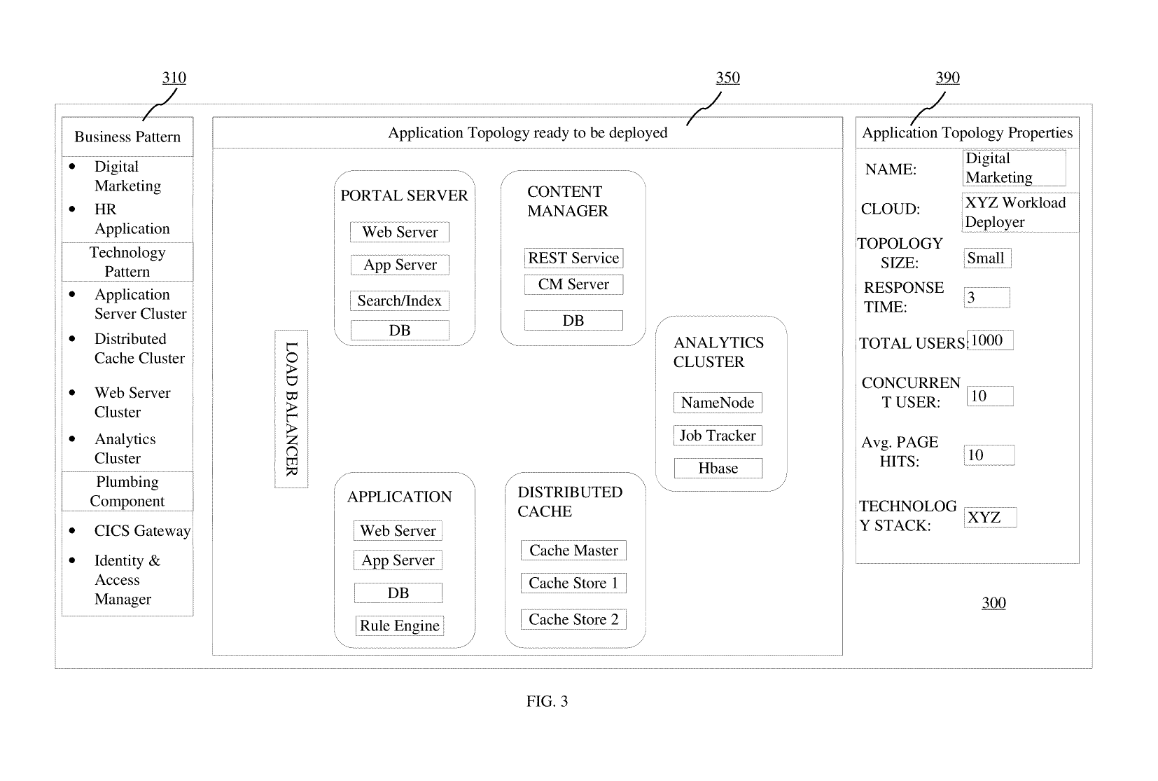

At step 130, application topology and deployment strategy are determined based on the received QoS parameters, workload attributes, application topology element and application topology patterns. The deployment strategy could be any of the deployment options, for example, clustered or non-clustered environment, private or public cloud environment or dedicated virtual environment etc. The deployment strategy may also include the factors pertaining to the total cost of ownership (TCO). The application topology pattern herein refers to different patterns of application topology based on standard application topology patterns; the one or more QoS parameters and the one or more virtual environment components. Such application topology patterns can be pre-defined and stored in a repository. The details of the determination of the application topology and deployment strategy are provided in FIG. 3.

For example, in one embodiment, based on the user provided inputs on the QoS demand for a selected business domain, the application topology is automatically designed considering the high availability demands, data archival needs, application user load projections etc. The application topology defines and describes the build, test and production environments in terms of size, location, interconnections, middleware components, application components, data synchronization, data archival, data recovery models etc. based on the QoS demands for each of those environments. Such application topology may be created as a virtual image.

At step 150, virtual environment component are identified based on the determined application topology and the deployment strategy. The identified virtual environment component may include, but not limited to operating system, software, hardware, middleware or the combination thereof. Once the virtual environment components are identified, a cloud deployer may implement the virtual environment component in the virtual environment. For example, if the application topology specifies 2 application servers and 1 web server, then the cloud deployer may search for the available resources and provision 2 available application servers and 1 web server for the specified application topology.

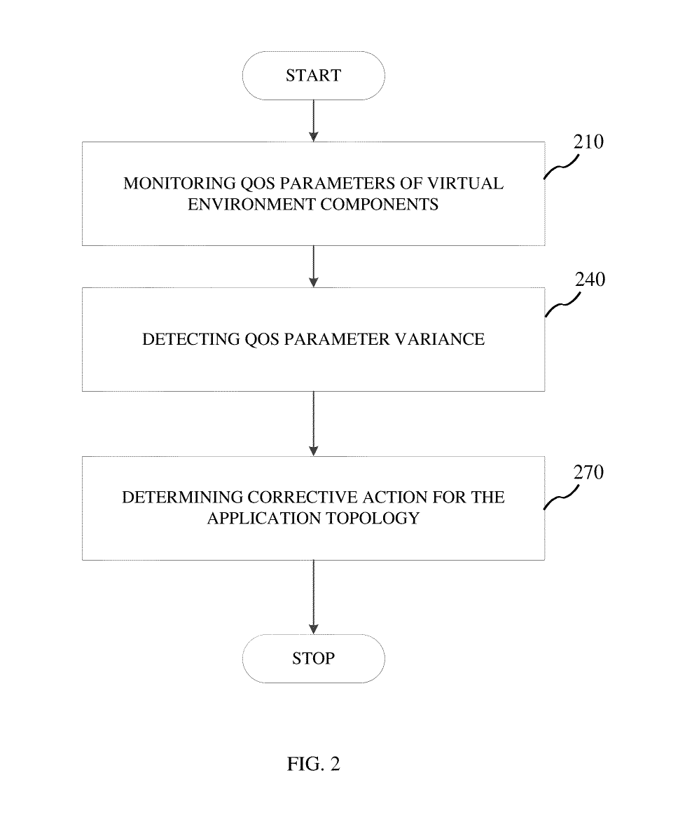

FIG. 2 illustrates a process flow for managing an application topology in a virtual environment. At step 210, QoS parameters of one or more virtual environment components are monitored. Typically, these QoS parameters comprise of the performance details of the virtual environment components. At step 240, any variance in the actual value of monitored QoS parameter, measured from a virtual environment component, from the expected value of the QoS parameter is detected. For example: if the QoS parameter for a virtual environment component specifies the response time of that component as x milliseconds and the expected response time is y milliseconds then the QoS parameter variance can be the difference between x and y. At step 270, corrective action for the application topology is determined, if the detected QoS parameter variance exceeds the pre-defined threshold.

FIG. 3 illustrates an example embodiment of an application topology determined based on the QoS parameters.300 depicts a representation of the application topology along with its properties. After receiving the parameters such as QoS parameters, workload attributes and application topology elements, an application topology is identified from the application topology patterns corresponding to the received parameters. Different application topology pattern references such as references for business pattern, technology pattern and plumbing component are shown for illustration purpose in block 310. The details of application topology pattern may be stored in a repository. Each application topology pattern corresponds to varying QoS parameters, hence, an application topology pattern is selected based on the required QoS parameters. Block 350 displays the selected application topology which can be deployed in a virtual environment. For example, application topology corresponding to the digital marketing pattern is selected if it met the required received parameters (QoS parameters, workload attributes and application topology elements). As shown for the purpose of illustration in block 350, the application topology comprises of the application topology elements such as REST service, CM server and database required for the content manger; web server, application server, database and rule engine required for an application; cache master, cache store 1 and cache store 2 are required for distributed cached and similarly other elements are listed for Analytics cluster and portal server. In case more cache is required for the application as per the requirements, an additional cache store can be included in the distributed cache stack.

Block 390 displays the properties of the application topology displayed in block 350. For example, for the selected digital marketing topology, the virtual environment is XYZ workload deployer, topology size is small, response time is 3 millisecond, total users are 1000, concurrent users are 10, average page hits are 10 and technology stack used is that of XYZ Company.

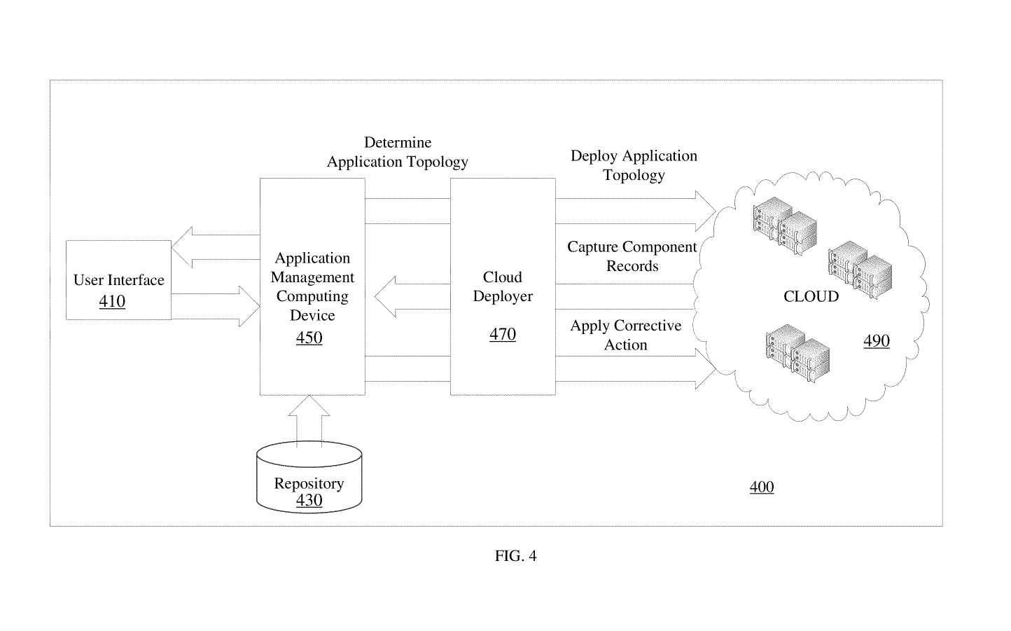

FIG. 4 shows an exemplary system depicting the components required to determine, manage and deploy an application topology in a virtual environment. System 400 comprises of a user interface 410, repository 430, an application management computing device 450, a cloud deployer 470 and a cloud 490. User interface 410 receives data corresponding to QoS parameters, workload attributes and application topology elements. Such data may be provided by a user or by one or more computing devices. Repository 430 depicts a database which can store different application topology pattern corresponding to the varying QoS parameters, workload attributes and application topology elements.

Application management computing device 450 determines the application topology and deployment strategy based on the received QoS parameters, the workload attributes, the application topology elements and the stored application topology patterns. For example, an application topology can be determined based on the factors such as number of users, application message throughput, application availability and latency. Based on the determined application topology and deployment strategy, virtual environment components are identified. As appreciated by the person skilled in the art, the application management computing device can have one or more components comprising of one or more processors and a memory coupled with the processors to perform the above mentioned steps.

Cloud deployer 470 deploys the application topology determined by the application management computing device 450 onto the cloud 490. For example, in one embodiment, the application topology can be created as a virtual image by the application management computing device 450 and then be deployed by the cloud deployer 470 onto the cloud 490.

After the application topology is deployed onto the virtual environment, it can be managed based on the virtual environment characteristics like utilization. Such characteristics will be monitored on an on-going basis. If the measurement of any of such characteristics crosses a pre-determined threshold, the application topology will be modified and deployed to suit the new virtual environment characteristics.

### Exemplary Computing Environment

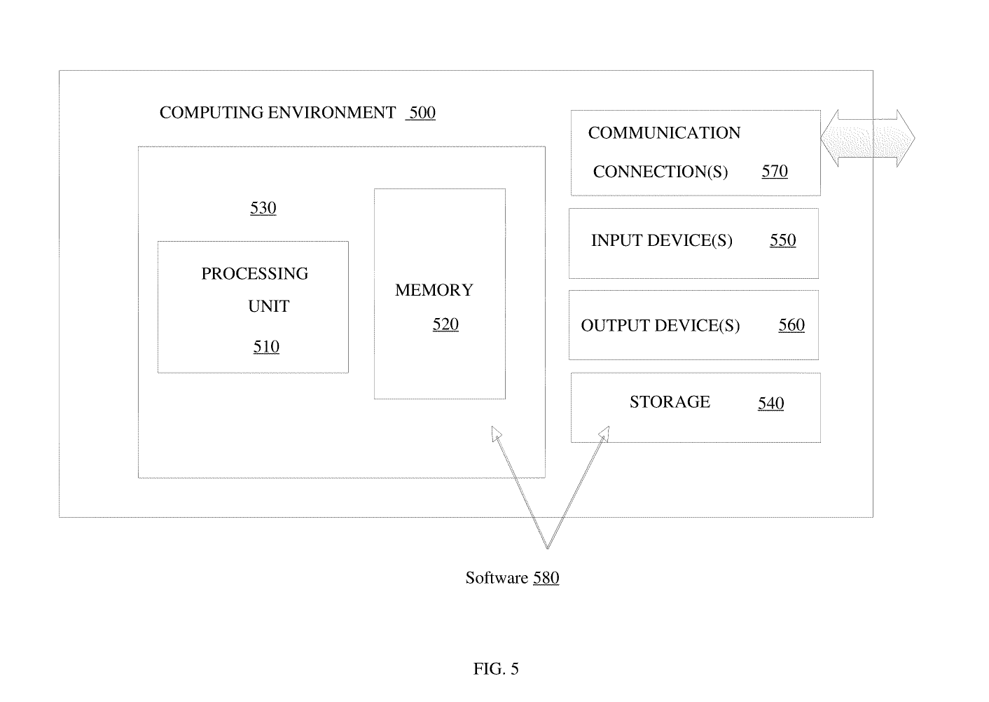

One or more of the above-described techniques may be implemented in or involve one or more computer systems. FIG. 5 illustrates a generalized example of a computing environment 500. The computing environment 500 is not intended to suggest any limitation as to scope of use or functionality of described embodiments.

With reference to FIG. 5, the computing environment 500 includes at least one processing unit 510 and memory 520. In FIG. 5, this most basic configuration 530 is included within a dashed line. The processing unit 510 executes computer-executable instructions and may be a real or a virtual processor. In a multi-processing system, multiple processing units execute computer-executable instructions to increase processing power. The memory 520 may be volatile memory (e.g., registers, cache, RAM), non-volatile memory (e.g., ROM, EEPROM, flash memory, etc.), or some combination of the two. In some embodiments, the memory 520 stores software 580 implementing described techniques.

A computing environment may have additional features. For example, the computing environment 500 includes storage 540, one or more input devices 550, one or more output devices 560, and one or more communication connections 570. An interconnection mechanism (not shown) such as a bus, controller, or network interconnects the components of the computing environment 500. Typically, operating system software (not shown) provides an operating environment for other software executing in the computing environment 500, and coordinates activities of the components of the computing environment 500.

The storage 540 may be removable or non-removable, and includes magnetic disks, magnetic tapes or cassettes, CD-ROMs, CD-RWs, DVDs, or any other medium which may be used to store information and which may be accessed within the computing environment 500. In some embodiments, the storage 540 stores instructions for the software 580.

The input device(s) 550 may be a touch input device such as a keyboard, mouse, pen, trackball, touch screen, or game controller, a voice input device, a scanning device, a digital camera, or another device that provides input to the computing environment 500. The output device(s) 560 may be a display, printer, speaker, or another device that provides output from the computing environment 500.

The communication connection(s) 570 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations may be described in the general context of computer-readable media. Computer-readable media are any available media that may be accessed within a computing environment. By way of example, and not limitation, within the computing environment 500, computer-readable media include memory 520, storage 540, communication media, and combinations of any of the above.

### Further Embodiments

A. An application management computing device for managing an application topology in a virtual environment, the device comprising:

a processor; and

a memory operatively coupled to the processor, the memory storing computer executable instructions which, when executed by the processor, cause the processor to carry out the method comprising:

monitoring one or more QoS parameters of one or more virtual environment components;

detecting at least one QoS parameter variance by analyzing the one or more monitored QoS parameters with an expected QoS parameters; and

determining at least one corrective action for the application topology if the detected at least one QoS parameter variance exceeds the pre-defined threshold.

B. The application management computing device of A wherein the processor further carry out the method comprising:

implementing the at least one corrective action on the virtual environment components.

C. A system for determining and deploying an application topology in a virtual environment, comprising:

a user interface configured to receive one or more of QoS parameters, at least one workload attributes and a plurality of application topology elements;

an application management computing device configured to:
determine the application topology and deployment strategy based on the received one or more of QoS parameters, the at least one workload attributes, the plurality of application topology elements and one or more application topology patterns; and
identify one or more virtual environment components based on the determined application topology and the deployment strategy; and

a database configured to store the one or more application topology pattern.

D. The system of C further comprising:

a cloud deployer configured to deploy the identified one or more virtual environment components in the virtual environment.

E. A system for managing an application topology in a virtual environment, comprising:

an application management computing device configured to:
monitor one or more QoS parameters of one or more virtual environment components;
detect at least one QoS parameter variance by analyzing the one or more monitored QoS parameters with an expected QoS parameters; and
determine at least one corrective action for the application topology if the detected at least one QoS parameter variance exceeds a pre-defined threshold; and

a database, configured to store the pre-defined threshold.

F. The system of E, further comprising:

a cloud deployer configured to implement the at least one corrective action on the virtual environment components.

G. A computer-readable code stored on a non-transitory computer-readable medium that, when executed by a computing device, performs a method for determining and deploying an application topology in a virtual environment, the method comprising:

receiving one or more of QoS parameters, at least one workload attributes and a plurality of application topology elements;

determining the application topology and deployment strategy based on the received one or more of QoS parameters, the at least one workload attributes, the plurality of application topology elements and one or more application topology patterns; and

identifying one or more virtual environment components based on the determined application topology and the deployment strategy.

H. The computer-readable medium of G, the method further comprising:

deploying the identified one or more virtual environment components in the virtual environment.

I. A computer-readable code stored on a non-transitory computer-readable medium that, when executed by a computing device, performs a method for managing an application topology in a virtual environment, the method comprising:

monitoring one or more QoS parameters of one or more virtual environment components;

detecting at least one QoS parameter variance by analyzing the one or more monitored QoS parameters with an expected QoS parameters; and

determining at least one corrective action for the application topology if the detected at least one QoS parameter variance exceeds the pre-defined threshold.

H. The computer-readable medium of I, the method further comprising:

implementing the at least one corrective action on the virtual environment components.

Having described and illustrated the principles of our invention with reference to described embodiments, it will be recognized that the described embodiments may be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

In view of the many possible embodiments to which the principles of our invention may be applied, we claim as our invention all such embodiments as may come within the scope and spirit of the following claims and equivalents thereto.

What is claimed is:

1. A method for determining and deploying an application topology in a virtual environment, the method comprising:
receiving, by an application management computing device, one or more of QoS parameters, at least one workload attributes and a plurality of application topology elements;
determining, by the application management computing device, the application topology and deployment strategy based on the received one or more of QoS parameters, the at least one workload attributes, the plurality of application topology elements and one or more application topology patterns;
identifying, by the application management computing device, one or more virtual environment components based on the determined application topology and the deployment strategy; and
providing, by the application management computing device, the one or more virtual environment components.

2. The method of claim 1, further comprising:
deploying the one or more virtual environment components in the virtual environment.

3. The method of claim 1, wherein the one or more QoS parameters comprise:
a response time;
a utilization level;
a throughput parameter;
a number of users; and
a number of concurrent users.

4. The method of claim 1, wherein the plurality of application topology elements comprise:
number of one or more application packages;
interdependencies between the one or more application packages; and
configuration of the one or more application packages.

5. The method of claim 1, wherein the one or more application topology patterns are per-identified based on one or more standard application topology; the one or more QoS parameters; and the one or more virtual environment elements.

6. A method for managing an application topology in a virtual environment, the method comprising:
monitoring, by an application management computing device, one or more QoS parameters of one or more virtual environment components;
detecting, by an application management computing device, at least one QoS parameter variance by analyzing the one or more monitored QoS parameters with an expected QoS parameters; and
determining, by an application management computing device, at least one corrective action for the application topology if the detected at least one QoS parameter variance exceeds the pre-defined threshold.

7. The method of claim 6, further comprising:
implementing the at least one corrective action on the virtual environment components.

8. A application management computing device for determining and deploying an application topology in a virtual environment, the device comprising:
a processor; and
a memory operatively coupled to the processor, the memory storing computer executable instructions which, when executed by the processor, cause the processor to carry out a method comprising:
receiving one or more of QoS parameters, at least one workload attributes and a plurality of application topology elements;
determining the application topology and deployment strategy based on the received one or more of QoS parameters, the at least one workload attributes, the plurality of application topology elements and one or more application topology patterns; and
identifying one or more virtual environment components based on the determined application topology and the deployment strategy.

9. The application management computing device of claim 8, wherein the processor further carries out the method comprising:
deploying the identified one or more virtual environment components in the virtual environment.

10. The application management computing device of claim 8, wherein the one or more QoS parameters comprise:
a response time;
a utilization level;
a throughput parameter;
a number of users; and
a number of concurrent users.

11. The application management computing device of claim 8, wherein the plurality of application topology elements comprise:
number of one or more application packages;
interdependencies between the one or more application packages; and
configuration of the one or more application packages.

12. The application management computing device of claim 8, wherein the one or more application topology patterns are per-identified based on one or more standard application topology; the one or more QoS parameters and the one or more virtual environment elements.
